(19) United States
(12) Patent Application Publication
(10) Pub. No.: US 2003/0141840 A1
(43) Pub. Date: Jul. 31, 2003

(54) Recharging system for personal electronic devices

(76) Inventor: Grant Sanders, Dallas, TX (US)

Correspondence Address: Michael A. O'Neil, Michael A. O'Neil, P.C., Suite 820, 5949 Sherry Lane, Dallas, TX, 75225, US

(21) Appl. No.: 10/353,370

(22) Filed: Jan. 28, 2003

Related U.S. Application Data
(60) Provisional application No. 60/352,812, filed on Jan. 29, 2002.

(51) Int. Cl. H02J 7/00

(52) U.S. Cl. 320/107

(57) ABSTRACT

A recharging station for personal electronic devices comprises a plurality of individual recharging lockers each having a plurality of substantially different recharging electrical connectors contained therein. Each recharging locker is provided with a lockable door. An activation system locks the door of a selected locker and supplies recharging electrical power to the connectors therein in response to the receipt of a prescribed fee. A recharging system for personal electronic devices useful in hotel rooms, motel rooms, and similar facilities includes a recharging station having a plurality of recharging electrical connectors secured thereto and a microprocessor for supplying recharging electrical power to the recharging electrical connectors.

### CLAIM OF PRIORITY

This application claims priority of prior provisional Application Ser. No. 60/352,812 filed Jan. 29, 2002, currently pending.

### TECHNICAL FIELD

This invention relates generally to the recharging of personal electronic devices, such as cell phones, lap top and palm top computers, personal digital assistants, and the like, and more particularly to a facility for securely receiving and recharging such devices upon the receipt of a prescribed fee. The invention further relates to the recharging of personal electronic devices in hotel rooms, motel rooms, and similar venues.

### BACKGROUND AND SUMMARY OF THE INVENTION

Cellular telephones are now used throughout the world, often in preference to conventional fixed base telephone facilities. Other personal electronic devices, such as lap top and palm top computers, personal digital assistants, hand held calculators, etc. are also widely used. Perhaps the only significant difficulty attendant to the use of personal electronic devices involves the fact that in order to provide small size and light weight and thereby facilitate portability, it is necessary to provide personal electronic devices with batteries which are small in size and light in weight. This in turn means that personal electronic devices which are convenient to carry and use necessarily require frequent recharging.

Recharging of personal electronic devices is straightforward if the owner of the device has access to a conventional electric power outlet. Likewise, most cellular telephones and other personal electronic devices are provided with accessories to facilitate recharging thereof utilizing the cigarette lighter receptacle of a vehicle. However, when the owner of a personal electronic device is involved in air travel, access to a conventional electric power outlet or to the cigarette lighter receptacle of a vehicle may be problematic. Similarly, when the owner of a personal electronic device is attending a seminar or convention, recharging of the device may be difficult if not impossible.

Another problem involved in the use of personal electronic devices is the bulky and cumbersome nature of the recharging apparatus that is typically furnished with such services. This frequently results in the recharging device being left behind which in turn results in the owner of a personal electronic device being left stranded with no means to effect recharging.

The present invention comprises a recharging station for cellular telephones and other personal electronic devices which overcomes the foregoing and other difficulties which have long since characterized the prior art. In accordance with one aspect of the invention, a recharging station comprises a plurality of individual recharging lockers. Each of the recharging lockers is provided with various types and kinds of connectors thereby facilitating the recharging of various types and kinds of personal electronic devices.

Access is gained to an individual recharging locker by payment of a prescribed fee. The personal electronic device to be recharged is secured within the locker during the recharging process. When the recharging process is complete, the recharging locker is once again opened to facilitate removal and use of the recharged personal electronic device.

In accordance with another aspect of the invention a recharging station for personal electronic devices is provided in hotel rooms, motel rooms, and similar places of public accommodation. The recharging station is equipped with a wide variety of connectors and is thereby adapted to the recharging of virtually every commercially available personal electronic device. Access to the recharging station is provided either as an amenity or at a modest fee.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of a recharging station for personal electronic devices incorporating a first embodiment of the invention;

FIG. 2 is a perspective view illustrating one of the recharging lockers of the recharging station of FIG. 1;

FIG. 3 is a diagrammatic illustration of a recharging station for personal electronic devices incorporating a second embodiment of the invention; and

FIG. 4 is an illustration of a typical utilization of the second embodiment of the invention.

### DETAILED DESCRIPTION

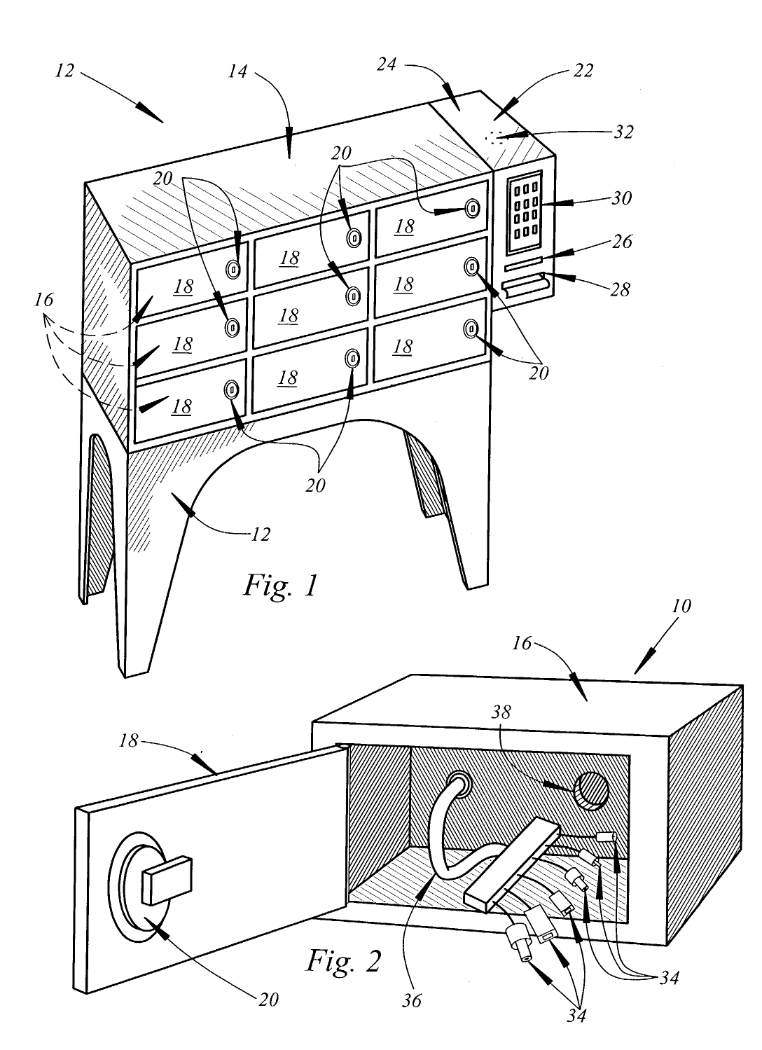

Referring now to the Drawings, and particularly to FIG. 1 thereof, there is shown a recharging station for personal electronic devices 10 comprising a first embodiment of the invention. The recharging station 10 is illustrated in FIG. 1 as supported on a stand 12. However, those skilled in the art will know and understand that the mounting or support for the recharging station 10 is not critical to the practice of the invention, and that the recharging station 10 may be mounted or supported utilizing a wide variety of conventional techniques depending upon the requirements of particular applications of the invention.

The recharging station 10 includes a housing 14 defining a plurality of individual recharging lockers 16. As is best shown in FIG. 2, each of the recharging lockers 16 is provided with a hingedly supported door 18. Each door 18 is in turn provided with a lock 20.

Referring again to FIG. 1, the recharging station 10 further comprises an actuation apparatus 22 comprising a housing 24 which is either securely mounted on or incorporated as part of the housing 14. The actuation apparatus 22 includes a slot 26 for receiving credit cards, debit cards, ATM cards, and the like, and a slot 28 for receiving currency. A keyboard 30 is provided for entering data into the actuation apparatus 22. A speaker 32 may be employed for various conventional purposes such as requiring and subsequently acknowledging the entry of personal identification numbers.

Referring particularly to FIG. 2, each recharging locker 16 comprising the recharging station 10 is provided with a variety of electrical connectors 34. In this manner the use of the recharging station 10 to recharge a wide variety of personal electronic devices including virtually every brand of lap top and palm top computer, every brand of cellular telephone, every brand of personal digital assistant, every brand of portable calculator, etc. is facilitated. Appropriate operating power is provided to each connector 34 through a cable 36. The recharging locker 16 may also be provide with an electrical receptacle 38 of the type utilized to actuate cigarette lighters in vehicles, thereby facilitating the recharging of personal electronic devices that do not match any of the connectors 34.

In accordance with a first operational scenario for the recharging station 10, the doors 18 of any currently unused recharging lockers 16 of the recharging station 10 are unlocked. A customer opens a selected door 18, connects a personal electronic device to be recharged to one of the connectors 34 or to the receptacle 38, and thereafter closes the door 18 of the recharging locker 16 in which the personal electronic device has been located. Utilizing either the card receiving slot 26 or the currency receiving slot 28, the customer pays the prescribed fee. The customer then utilizes the keyboard 30 to input the number of the recharging locker 16 in which the personal electronic device to be recharged is located.

Upon receipt of the prescribed fee and inputting of the number of the recharging locker 16 in which a personal electronic device to be recharged has been located, the activation system 22 turns on the recharging power within the selected recharging locker 16 and locks the door 18 thereof. The activation system 22 also releases a key from the door 18 of the selected recharging locker 16 for removal by the customer. After a predetermined recharging interval, the customer returns and employs the key to open the door 18 of the recharging locker 16 in which the now recharged personal electronic device is situated. Actuation of the key turns off operating power within the selected recharging locker 16 and otherwise returns the recharging station 10 to its original configuration.

In accordance with a second operational scenario the doors 18 of the recharging locker 16 remain locked until the prescribed fee has been paid utilizing either the card receiving slot 26 or the currency receiving slot 28. After the prescribed fee has been received, the speaker 32 instructs the customer to utilize the keyboard 30 to enter a personal identification number which is randomly selected by the customer. Upon entry of the personal identification number, the door to an unused recharging locker 16 comprising the recharging station 10 is opened. The customer places the personal electronic device to be recharged within the now open recharging locker 16 and connects the device to be recharged to one of the connectors 34 or the receptacle 38. The door 18 of the recharging locker in which the cellular telephone other electronic device to be recharged is located is then closed.

Upon closure the door 18 is automatically locked and the recharging process is initiated. After a predetermined time period the customer returns to the recharging station 10 to recover the now recharged personal electronic device. The customer re-enters the personal identification number utilizing the keyboard 30. Re-entry of the personal identification number opens the door to the recharging locker 16 having the customer's personal electronic device located therein. The customer recovers the personal electronic device and closes the door 18 which returns the charging station 10 to its original configuration.

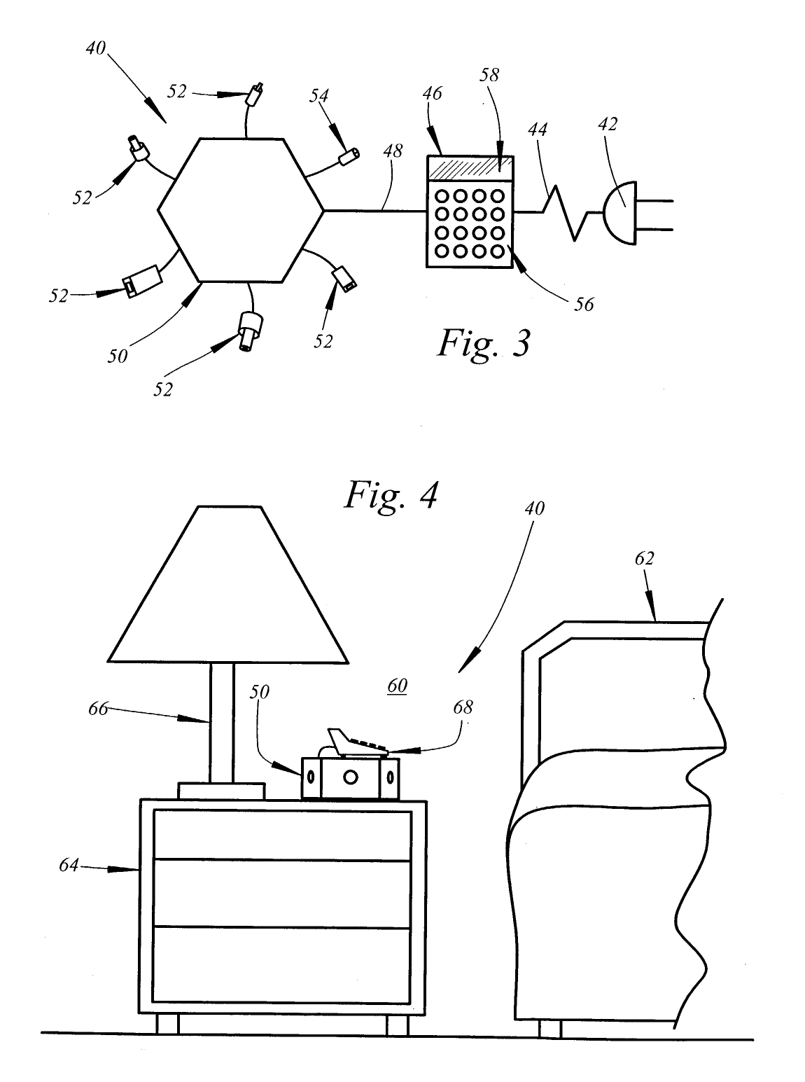

Referring to FIGS. 3 and 4, there is shown a system 40 for recharging personal electronic devices in hotel rooms, motel rooms, and similar facilities comprising a second embodiment of the invention. As is best shown in FIG. 3, the recharging system 40 receives electrical power through a conventional electrical plug 42 of the type adapted for use with a conventional electrical convenience outlet (not shown). Electrical power received through the electrical plug 42 is directed through a conventional electrical line 44 to a microprocessor 46. The microprocessor 46 converts the electrical power received through the line 44 to an electrical power level appropriate for recharging a particular personal electronic device and characterized by predetermined voltage and current levels. Recharging electrical power is directed from the microprocessor 46 through a line 48 to a recharging station 50.

The recharging station 50 is provided with a plurality of recharging connectors 52 each individual to a particular brand of personal electronic device. The present invention contemplates that the vast majority of personal electronic devices in common use will be rechargeable through one of the recharging connectors 52. The recharging station 50 is also provided with a universal connector 54 which. is adapted for connection to recharging connectors associated with rarely used personal electronic devices. In this manner virtually every personal electronic device currently in use can be recharged using the recharging station 50.

Preferably, the microprocessor 46 is adapted to recognize a particular personal electronic device that is connected to the charging station 50 through one of the recharging connectors 52 or the universal recharging connector 54. In such instances the microprocessor 46 automatically determines the correct voltage and current levels of the recharging power that will be supplied to the personal electronic device requiring recharging through the line 48, the recharging station 50, and the selected recharging connector 52 or 54. In some instances, however, it may be necessary to input instructions through the microprocessor in order to ensure that recharging power characterized by appropriate voltage and current levels is supplied to the personal electronic device that is connected to the recharging station 50 through one of the recharging connectors 52 or the recharging connector 54. To this end the microprocessor 46 may be provided with a keyboard or other instruction inputting device 56 and an appropriate display device 58.

The recharging system 40 comprising the present invention is adapted for use in hotel rooms, motel rooms, and similar venues to effect recharging of personal electronic devices that are the property of guests utilizing the facility. FIG. 4 illustrates a typical hotel room/motel room 60 which is characterized by a bed 62, a night stand 64, a lamp 66, a telephone 68, etc. In accordance with the present invention the recharging station 50 of the recharging system 40 may be mounted on the night stand 64 in close proximity to the bed 62 and the other amenities comprising the hotel room/motel room 60. Larger hotel rooms and/or motel rooms may be provided with desks, tables, credenzas, etc. all of which may be utilized as an appropriate support for the recharging station 50, if desired.

As is illustrated in FIG. 4, the recharging station 50 of the recharging system 40 does not require any sort of enclosure, and is preferably deployed in an open, accessible manner so as to facilitate use thereof. In some instances, however, it may be deemed preferable to position the microprocessor 46 and the charging station 50 of the recharging system 40 within a lockable enclosure, such as the enclosure 16 illustrated in FIG. 2 and described hereinabove in connection therewith. In such instances the guest utilizing the recharging station 50 positions the personal electronic device to be recharged within the lockable enclosure, closes the door thereof, and locks the enclosure during the recharging process.

In the use of the recharging system 40 a guest arrives at a hotel, motel, or similar facility; checks in; and is provided access to a particular hotel/motel room. Upon entering the assigned hotel/motel room, the guest attaches his or her personal electronic device requiring recharging to the recharging station 50 utilizing the recharging connector 52 associated with the particular brand of the personal electronic device requiring recharging. In the case of a personal electronic device which does not match any of the recharging connectors 52 the guest receives an appropriate recharging connector from the management of the hotel, motel, or similar facility and uses the received recharging connector to connect the personal electronic device requiring recharging to the recharging station 50 through the universal connector 54.

The recharging system 40 of the present invention is typically made available free of charge to guests utilizing a particular hotel, motel, or similar facility and as such comprises an amenity of the facility. In other instances a modest fee may be charged for the use of the recharging system 40. In the latter instance the recharging system is electronically connected to the management facilities of the hotel, motel, or similar facility so as to facilitate management control over the operation thereof.

Although preferred embodiments of the invention have been illustrated in the accompanying Drawing and described in the foregoing Detailed Description, it will be understood that the invention is not limited to the embodiments disclosed but is capable of numerous rearrangements, modifications, and substitutions of parts and elements without departing from the spirit of the invention.

1. A recharging station for personal electronic devices comprising:
a housing defining a plurality of individual recharging lockers each having a lockable door;
each of the recharging lockers having a plurality of substantially different recharging connectors contained therein;
means for supplying recharging electrical power to each of the recharging electrical connectors within each of the recharging lockers comprising the recharging station; and
control means for locking the door of a selected recharging locker and for actuating the electrical power supplying means to direct recharging electrical power to the selected recharging locker in response to the receipt of a prescribed fee.

2. The recharging station according to claim 1 wherein the recharging electrical power that is supplied to each recharging electrical connector is characterized by predetermined voltage and current levels.

3. The recharging station according to claim 1 wherein each of the recharging electrical connectors is applicable to a particular type of personal electronic device.

4. A recharging station for personal electronic devices comprising:
a housing defining a recharging locker having a lockable door;
the recharging locker having a plurality of substantially different recharging connectors contained therein;
means for supplying recharging electrical power to each of the recharging electrical connectors within the recharging locker comprising the recharging station; and
control means for locking the door of the recharging locker and for actuating the electrical power supplying means to direct recharging electrical power to the selected recharging locker.

5. The recharging station according to claim 4 wherein the recharging electrical power that is supplied to each recharging electrical connector is characterized by predetermined voltage and current levels.

6. The recharging station according to claim 4 wherein each of the recharging electrical connectors is applicable to a particular type of personal electronic device.

7. A recharging system for personal electronic devices comprising:
a recharging station;
a plurality of individual recharging electrical connectors each mechanically and electrically connected to the recharging station;
a source of electrical power; and
a microprocessor electrically connected between the source of electrical power and the recharging station for supplying each of the recharging electrical connectors with recharging electrical power characterized by predetermined voltage and current levels.

8. The recharging station according to claim 7 wherein each of the recharging electrical connectors is applicable to a particular type of personal electronic device.

9. The recharging station according to claim 7 further including data input means for controlling the operation of the microprocessor.

10. The recharging system according to claim 7 wherein the recharging station and the electrical connectors thereof are positioned within a lockable enclosure.
